(19) United States
(12) Patent Application Publication
(10) Pub. No.: US 2014/0263191 A1
(43) Pub. Date: Sep. 18, 2014

(54) SYSTEM AND METHOD OF WELDING STAINLESS STEEL TO COPPER

(71) Applicant: LINCOLN GLOBAL, INC., City of Industry, CA (US)

(72) Inventors: Alvaro ZAPATA, Miramar, FL (US); Paul E. Denney, Bay Village, OH (US); Michael D. Latessa, Chesterland, OH (US); Maxwell Radke, Painesville, OH (US)

(21) Appl. No.: 13/840,769

(22) Filed: Mar. 15, 2013

(51) Int. Cl. B23K 28/02; B23K 9/16; B23K 26/38

(52) U.S. Cl. CPC B23K 28/02; B23K 26/38; B23K 9/164
USPC 219/74; 219/121.72; 219/137.2

(57) ABSTRACT

A system and method of welding stainless steel to copper is provided. The method includes providing a first workpiece composed of stainless steel and providing a second workpiece composed of copper. The method also includes heating by using a laser a root area of a joint created by the workpieces. The heating by the laser creates a keyhole in at least one of the first workpiece and the second workpiece. The method also includes providing a consumable electrode that is composed of nickel to the joint and creating an arc between the consumable electrode and the joint using a welding current. The preheating of the arc using the keyhole eliminates the need to preheat the second workpiece.

### TECHNICAL FIELD

Certain embodiments relate to hybrid laser systems in welding, and joining applications. More particularly, certain embodiments relate to a system and method that uses a hybrid laser GMAW system for joining and welding applications.

### BACKGROUND

Welding of stainless steel to copper is known. In many applications the stainless steel is welded to the copper using pure nickel wire. Such processes typically requires preheat due to nickel's poor watering capabilities in the welding process. Further, such welds are being performed manually using GTAW only. However, in such processes stainless steel is subject to distortion, especially when the steel is relatively thin. As such, it is desirable to avoid preheating. Nevertheless, GTAW welding of stainless steel with copper is being performed due to the nickel's better corrosion resistance as compared to a copper based wire. In known methods of welding copper to stainless steel, the copper workpiece must be cooled down, e.g. 50% to 80% of the copper workpiece may need to be submerged in chilled water to prevent overheating and penetration into the copper, and the GTAW process requires a shielding gas of 100% helium (e.g., at 35 CFH), which is relatively expensive and difficult to procure. In addition, the process is highly inefficient with deposition rates around 1.54 lb/hr (0.7 kg/hr) using a 3/32″ AWS ER Ni-1 rod. The travel speed for the GTAW process is between 8 to 10 ipm (0.2-0.25 m/min). Further, there are little to no gains in efficiency when using an automated GTAW process as opposes to manual GTAW.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use join stainless steel to copper. The method includes providing a first workpiece composed of stainless steel and providing a second workpiece composed of copper. The method also includes heating by using a laser a root area of a joint created by the workpieces. The method includes providing a consumable electrode that is composed of nickel to the joint and creating an arc between the consumable electrode and the joint using a welding current. A laser beam creates a keyhole in the puddle created by the arc weld that joins between the first workpiece and the second workpiece. The laser beam carries the arc puddle into the base workpiece using the keyhole which eliminates the need to preheat the second workpiece.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a system consistent with the present invention;

FIG. 2 illustrates a top view of the system of FIG. 1; and

FIG. 3 illustrates a cross-sectional view of an exemplary weld created by the system of FIG. 1.

### DETAILED DESCRIPTION

Exemplary embodiments of the invention will now be described below by reference to the attached Figures. The described exemplary embodiments are intended to assist in the understanding of the invention, and are not intended to limit the scope of the invention in any way. Like reference numerals refer to like elements throughout.

Exemplary embodiments of the present invention include a hybrid laser system that is used to create the weld between a stainless steel workpiece and a copper workpiece. Use of a hybrid laser system allows for smaller weld bead size, faster travel speeds, less distortion and a more efficient welding process. This is because, by combining the focused energy of a laser beam with a conventional arc system, such as a GMAW system, to melt the base metal, the penetration of the molten puddle (i.e., weld puddle) is deeper than if just a conventional arc-only system was used. Further, greater penetration is achieved with less heat input from the process. For example, in an exemplary application of welding a T-joint in which two workpieces are joined (one of which is copper and the other is stainless steel), the hybrid laser system can provide deep penetration of the T-joint root on each side of the T-joint with a narrow heat-affected zone (HAZ). By using a laser, the weld bead size can be considerably smaller while still achieving the same, or better, cross section of fused material as that of a fillet weld made with a conventional arc-only system. In addition, due to the smaller bead size, less filler material is needed and the T-joint can be created at travel speeds that are higher than conventional arc-only systems. In some exemplary embodiments of the present invention, travel speeds can be in the range of 15 to 30 ipm, and in some embodiments in the range of 20 to 25 ipm. Further, because there is less molten metal using a laser process, there is less distortion than a conventional arc-only system. Accordingly, a cooling system—as needed in known welding operations—is not required. Further, the GMAW system does not require 100% helium shielding and inexpensive argon and be used. In some exemplary embodiments the argon is used at a flow rate of 35 to 40 CFH.

Because the general construction and operation of hybrid laser welding systems are known, the details of such a system and their general function need not be described herein. The following discussion of FIG. 1 is a general discussion, and the various systems that can be used with embodiments of the present invention are not limited to what shown in FIG. 1, or discussed below. As seen in FIG. 1, a hybrid system 100 includes a laser power supply 130 connected to laser 120, which emits laser beam 110. The laser 120 can be any type of high energy laser source, including but not limited to carbon dioxide, Nd:YAG, Yb-disk, Yb-fiber, fiber delivered or direct diode laser systems. Further, even white light or quartz laser type systems can be used if they have sufficient energy. For example, a high intensity energy source can provide at least 500 W/cm2. In addition, the laser should have the ability to “keyhole” into the root metal of the workpieces being welded. That is, the laser should have sufficient energy to form a vapor cavity in the root metal that can extend substantially into the root. In exemplary embodiments of the present invention, the root metal contemplated is copper (WP2) and the depth of penetration D is in the range of 1.75 to 4 mm, and in some embodiments can be in the range of 2 to 3 mm. (See FIG. 3). The system also includes a welding power supply 170, which is connected to a torch 160. The welding power supply can be a GMAW type power supply, and example of which is the Power Wave 455M manufactured by The Lincoln Electric Company of Cleveland Ohio. A wire feeder 150 feeds wire 140 to the root of the T-joint via the torch 160. The welding power supply 170 outputs welding current to the wire 140 via torch 160. The welding current creates an arc 112 between the wire 140 and the workpieces WP1 (stainless steel) and WP2 (copper). The arc 112 is protected from atmospheric contamination by a shielding gas. Because of the use of embodiments of the present invention, it is not necessary to use helium shielding gas—as with known systems, but rather a shielding gas of 100% argon can be used. The gas is supplied by the gas supply 180. The workpieces WP1 (stainless steel) and WP2 (copper) can be automatically moved, in concert, by travel mechanism 190 relative to the torch 160 and laser beam 110. Of course, the torch 160 can be moved instead of or in addition to the workpiece WP2. The direction of travel for the torch 160 and laser beam 110 along the T-joint is best seen in FIG. 2 by arrow 111. The sensing and current controller 195 can be operatively connected to laser power supply 130, welding power supply 170, wire feeder 150 and travel mechanism 190 to control the hybrid welding operation. In some embodiments, the controller 195 can be a parallel state based controller.

As shown in FIG. 1, an embodiment of the system can use a single laser and welding power supply to weld each side of a joint separately (if two joints are welded). However, embodiments are not limited in this regard and some system can use two separate power supplies and/or two separate laser system to weld each side of a joint at or near the same time. Such a system would save time, and because of the reduced heat input from using embodiments of the present invention, this can be done with little regard for distortion.

FIG. 2 is a top down view of weld joint which can be welded by exemplary embodiments of the system, where the top of the stainless steel (WP1) is shown as well as the weld face of the copper (WP2). In the embodiment shown in FIG. 2 a second welding system is contemplated so that both sides of the joint can be welded at the same time. The second system is using similar reference numerals to that in FIG. 1, except using a ′ to indicate the second system—see e.g., 110′, 140′, 160′. As shown in the embodiment of FIG. 2, the laser beam 110/110′ is focused just ahead of arc between the consumable 140/140′ and the puddle in order to create a keyhole at the root of the T-joint in the direction of travel 111. However, in some embodiments, the laser beam can be in the trailing position. The distance D between the laser beam 110 and the arc should be such that beam 110 interacts with the molten puddle. This ensures that the molten metal from the puddle is fully drawn into the keyholes created by the beam 110/110′. If the distance between the arc and the beam is too great the puddle can cool such that the molten metal will not fully wet into the keyholes created by the laser. Effectively, the laser beam 110/110′ creates the penetration that is needed without the increased heat input from a traditional arc process. In exemplary embodiments of the present invention, the beam also impacts the directly on the molten puddle. The laser penetrates the copper (WP2) through the puddle such that the molten filler material is drawn into the keyhole. If the beam is too far in front or too far behind the arc the laser beam 110 will provide no real benefit and the molten filler will not fully penetrate the keyhole. In exemplary embodiments of the present invention, the distance between the centerline of the laser beam 110 and the center of the arc is in the range of 1 to 4 mm, and in some exemplary embodiments is in the range of 1 to 3 mm. The keyhole from the laser into the WP2 (copper) is shown in FIG. 3 and as seen the laser penetrates a depth D. That is, the laser beam 110/110′ forms a keyhole that extends into workpiece WP2 at the root of the T-joint, e.g., the keyhole can extend into WP2 at a range of 1.75 to 4 mm, and in some exemplary embodiments the depth D is in the range of 2 mm to 3 mm.

Also as shown in FIG. 3, in some exemplary embodiments, at least a portion of the workpiece WP1 (stainless steel) at the joint is removed or eroded by the laser beam 110/110′ such that the thickness of the WP1 is reduced at the joint. This can be done to further promote a good fusion between the workpieces WP1 and WP2. In some exemplary embodiments, the smallest WP1 thickness at the joint is in the range of 85 to 100% of the original thickness of the WP1 prior to joining. In other exemplary embodiments, the smallest thickness of the stainless steel WP1 is in the range of 90 to 98% of the original thickness.

By using the laser along with the arc process as described herein, the penetration of the keyhole extends far enough into workpieces WP1 and WP2 such that appropriate bonding occurs without excessive heat input. In addition, the laser helps to preheat for the arc by allowing the arc to wet out sufficiently to achieve a smooth transition with minimal bead size. As shown in the exemplary embodiments of FIGS. 2 and 3, the T-joint utilizes fillet welds in both sides of WP1 (stainless steel) (see 114 and 116). As explained previously, in some embodiments each fillet 114/116 weld is done separately by the system 100. In other embodiments, the fillet welds 114 and 116 can be done concurrently using two GMAW systems and either a single laser 120 that can keyhole across the root of workpiece WP1, or a second laser can be used if desired.

In accordance with an exemplary embodiment of the present invention, the workpiece WP1, which can be a stainless steel (for example type 316L), is welded to workpiece WP2, which is composed of primarily of copper. These workpieces can be welded using the system of FIG. 1, or a similarly functioning system. Because of the use of the hybrid laser process as described herein, embodiments of the present invention can achieve travel speeds that can be in the range of 15 to 30 ipm, and in some embodiments in the range of 20 to 25 ipm. This is done with minimal heat input into the workpieces and with minimal distortion. Furthermore, the required preheat and active cooling of previous methodologies is eliminated. That is, in embodiments of the present invention it is not required to actively cool the copper workpiece WP2, as with prior methods.

During operation, the controller 195 also controls the wire feeder 150 such that the consumable wire 140 is properly delivered to the puddle. In exemplary embodiments the consumable 140 is a nickel based consumable of the type that can be used to join copper and stainless steel. An example of such consumables are AWS Er Ni-1, Techalloy 208 or Metrode Nickel-2Ti, or a similar wire. The wire is fed into the weld puddle created by the torch 160, as each of the fillets is created. Because the beam 110/110′ is also interacting with the puddle and creating the keyholes in WP2 the molten filler is drawn into the keyholes to provide the sufficient bonding. The wire 140 can be any standard filler diameter, e.g., 0.030 to 0.045. Because of the advantages of using embodiments of the present invention, the system 100 can provide deposit rates of the filler material in the range of 3 to 15 lb/hr. This is considerably improved over known systems. In further exemplary embodiments, the deposit rate can be in the range of 7 and 15 lbs/hr. These are speeds and deposition rates which greatly exceed that provided for by traditional systems used to join stainless steel to copper. As discussed above, preheating for the arc is achieved by the laser beam 110 which keyholes to a desired at the weld puddle. Furthermore, because of the use of the laser and the overall reduced heat input, a shielding gas of 100% argon can be used with embodiments of the present invention. Prior system required 100% helium. In exemplary embodiments of the present invention, the argon can be supplied to torch 160 in the range of 35 to 40 CFH.

Accordingly, embodiments of the present invention, unlike conventional processes, are able to take advantage of wire with the highest corrosion resistant alloys in a fully automatic process and with high production rates. In addition, due to the laser, the process can be done without having to preheat on copper. Thus, eliminating the need to providing cooling to keep the stainless from distorting.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the present application.

1. A method of welding stainless steel to copper, the method comprising:
providing a stainless steel workpiece;
providing a copper workpiece;
aligning an edge of the stainless steel workpiece to a surface of the copper workpiece to create a joint between the stainless steel workpiece and the copper workpiece;
directing a laser beam at the joint to create a keyhole in at least the copper workpiece;
providing a consumable electrode to the joint; and
creating an arc between the consumable electrode and the joint so that said arc creates a molten puddle at said joint and said consumable is deposited into the joint via said arc;
wherein said laser beam is directed at said joint such that said laser beam interacts with said molten puddle to allow said consumable to deposited fully into said keyhole in said copper workpiece created by said laser beam.

2. The method of claim 1, wherein said consumable electrode is a nickel based consumable.

3. The method of claim 1, wherein said keyhole in said copper workpiece extends to a depth of 1.75 to 4 mm from said surface of said copper workpiece.

4. The method of claim 1, wherein said keyhole in said copper workpiece extends to a depth of 2 to 3 mm from said surface of said copper workpiece.

5. The method of claim 1, further comprising advancing said consumable electrode and said arc along said joint at a travel speed in the range of 15 to 30 ipm.

6. The method of claim 1, further comprising advancing said consumable electrode and said arc along said joint at a travel speed in the range of 20 to 25 ipm.

7. The method of claim 1, further comprising providing a shielding gas of 100% argon to said joint.

8. The method of claim 7, wherein said shielding gas is provided at a rate of 35 to 40 CFM.

9. The method of claim 1, wherein said copper workpiece is not actively cooled during said welding.

10. The method of claim 1, further comprising reducing the thickness of said stainless steel workpiece at said joint such that said smallest thickness at said joint is in the range of 90 to 98% of the starting thickness of said stainless steel workpiece.

11. The method of claim 1, wherein said consumable is deposited in said joint at a rate in the range of 3 to 15 lb/hr.

12. The method of claim 1, wherein said consumable is deposited in said joint at a rate in the range of t to 15 lbs/hr.
